(19) United States
(12) Patent Application Publication
(10) Pub. No.: US 2010/0159428 A1
(43) Pub. Date: Jun. 24, 2010

(54) Children's Development Device With Multiple-Axis Motion

(75) Inventors: Elizabeth Grasing, Brooklyn, NY (US); Joshua E. Clapper, Downington, PA (US)

Correspondence Address: Lempia Braidwood Graco, One North LaSalle Street Suite 3150, Chicago, IL, 60602, US

(73) Assignee: Graco Children's Products Inc., Exton, PA (US)

(21) Appl. No.: 12/495,031

(22) Filed: Jun. 30, 2009

Related U.S. Application Data
(60) Provisional application No. 61/138,898, filed on Dec. 18, 2008.

(51) Int. Cl. G09B 19/00; A47D 1/00

(52) U.S. Cl. 434/258; 297/311

(57) ABSTRACT

A children's development device has a carrier coupled to a juvenile product and elevated above a support surface. The carrier defines an x-y-z axis system including a generally vertical z-axis, a generally horizontal x-axis and a generally horizontal y-axis oriented normal or perpendicular to the x-axis. A child seat is coupled to the carrier and positionable such that feet of an occupant of the seat can contact a launching surface. The child seat can, relative to the juvenile product, independently rotate about the z-axis, rotate about the x-axis, and rotate about the y-axis

### RELATED APPLICATION DATA

This patent is related to and claims priority benefit of U.S. provisional application Ser. No. 61/138,898 filed on Dec. 18, 2008 and entitled “Child Activity Center for Multiple-Axis Movement,” the entirety of which is hereby incorporated by reference.

### BACKGROUND

1. Field of the Disclosure

The present disclosure is generally directed to juvenile or children's products such as activity centers and entertainers, and more particularly to a development device that allows multiple-axis motion of the child supported by the device.

2. Description of Related Art

Parents have long dealt with the challenge of entertaining and stimulating their infants and toddlers, as well as assisting in the gross motor and physical development of their infants and toddlers. Many devices are known in the art that attempt to accomplish these goals. One such product that is commonly used for infants and young toddlers is known as an activity center or entertainer. A typical entertainer has a generally circular upper tray with a center opening surrounded by the tray. A sling-type seat is often positioned within the opening and suspended by the entertainer above the ground. The sling seat supports a child in the standing position and often allows the child to touch a surface with their feet or even to stand on their own feet while passively supported by the sling seat. The upper tray is typically supported above the ground by a base in a way that allows the child to play with various toys or other objects on top of the tray.

Some activity centers and entertainers have mechanisms that provide the child with self-power motion such as jumping and bouncing while being fully supported by the slung seat. In addition, some entertainers, activity centers, or other product types have feet that can resiliently move up and down to enhance the bouncing motion. Some products even have wheels on the bottom that allow the child to move the product along the ground surface. These types of products can permit the child to shuffle or walk with the activity center, as long as there feet can touch the ground while seated or standing within the sling seat, but do not promote physical development or improve balance. Existing activity centers do not help to develop core muscles, like those used for crawling, rolling over, rising up, and the like. These types of products, as a result, serve only to entertainer the child and or to strengthen their legs. Based on medical and occupational therapy research, these types of product do little or nothing to develop a child's motor skills and core muscles.

These are a number of known children's products that have attempted to address the goal of accelerating a child's gross motor skill development. These devices typically offer a relatively safe weight bearing structure for holding and/or suspending a child in a standing or upright position. Walkers, doorway jumpers, and stationary entertainers are just a few examples of devices designed to bear a portion of the child's weight, while still encouraging the child to use their leg muscles while maintaining a standing or upright position.

The vast majority of these known children's products and devices are typically directed to improving or just using only a subset of a child's gross motor skills. Such skills are recognized by healthcare professionals as being developed during early childhood. Gross motor skill development can often involve a wide range of muscle groups and other stimuli. For instance, motor skills are being developed in the upper body as well as the lower body. Core body muscles are often involved in more complex movements that involve combinations of twisting, bending, leaning, and the like while a child uses both the upper and lower extremities. Most of the known children's products only provide stimuli to the child's legs, and often only to standing or to vertical up and down movement.

### SUMMARY

A development device for physical and gross motor development of a child is disclosed herein that can permit independent motion of the child about multiple axes. In one example, a development device can have a base and a carrier coupled to the base and elevated above a support surface. The carrier defines an x-y-z axis system, which in a home configuration, includes a generally vertical z-axis, a generally horizontal x-axis, and a generally horizontal y-axis oriented perpendicular or normal to the x-axis. A child seat is coupled to the carrier and can, relative to the base, independently rotate about the z-axis, rotate about the x-axis, and rotate about the y-axis.

In one example, when the child seat rotates about the z-axis, an x-y plane defined by the x-axis and y-axis does not rotate about the z-axis.

In one example, when the child seat rotates about the z-axis, an x-y plane defined by the x-axis and y-axis also rotates about the z-axis with the child seat rendering the z-axis rotation a yaw motion, the x-axis rotation a pitch motion, and the y-axis rotation a roll motion relative to the child seat.

In one example, a development device can have one or more motion restrictors configured to permit selective adjustment of a rotational travel limit of a child seat, of a rotation resistance of the child seat, or both about one or more of an x-axis, y-axis, and z-axis.

In one example, a development device can have a support arm cantilevered at one end from a portion of a base. The carrier can be suspended from another end of the support arm opposite the one end. The base can be configured to rest on the support surface.

In one example, one end of a support arm of a development device is pivotally coupled to a portion of a base at a base axis that is oriented generally vertically such that the support arm and a carrier on the support arm can be rotated about the base axis.

In one example, a development device can have a motion restrictor configured to permit selective adjustment of a rotational travel limit of a support arm, of a rotation resistance of the support arm, or both about a base axis relative to the base.

In one example, a support arm and a carrier of a development device can reciprocally move in a generally vertically direction relative to a base.

In one example, a carrier of a development device can reciprocally move in a generally vertically direction relative to a base.

In one example, a development device can have a motion restrictor configured to permit selective adjustment of a vertical travel limit of a carrier, of a vertical motion resistance of the carrier, or both relative to a base.

In one example, a development device can have a four-bar linkage cantilevered at one end from an upright portion of a base. A carrier can be suspended from another end of the four-bar linkage opposite the one end and arranged to allow the carrier to reciprocate vertically. A spring mechanism can be coupled to the four-bar linkage and configured to render adjustable a vertical travel limit and the resistance to vertical reciprocation.

In one example, one end of a four-bar linkage of a development device can be pivotally coupled to an upright portion of a base at a base axis that is oriented generally vertically such that the four-bar linkage and a carrier can be rotated about the base axis relative to the base.

In one example, a development device for gross motor and physical development of a child can have a base and a carrier coupled to the base and elevated above a support surface. The carrier can have a gimbal-like structure that defines an x-y-z axis system. A child seat can be suspended from the carrier and be movable relative to each of the x, y, and z axes independent of the other of the x, y, and z axes.

In one example, a development device can have a child seat wherein rotational travel of the child seat relative to at least an x-axis and a y-axis is limited to about 10 degrees or less in each direction from a home position of the child seat with respect to each of the x- and y-axes.

In one example, a development device can have an adjustable motion restrictor for each of an x-axis, a y-axis, and a z-axis that each permit a rotational range limit, a resistance to rotation, or both of a child seat relative to each axis to be independently adjusted.

In one example, a development device can have a gimbal-like structure of a carrier that includes a first ring of a first diameter supported for rotation about an x-axis that bisects the first ring. When in a home position, the x-axis can be oriented generally horizontally and lengthwise relative to a base and permit side-to-side roll movement of a child seat.

In one example, rotational travel of a child seat on a development device about an x-axis, which in a home position is oriented generally horizontally and perpendicular to a y-axis can be limited to about 10 degrees or less in each direction from the home position.

In one example, a development device can have carrier with a gimbal-like structure can include a second ring supported by a first ring. The second ring can have a diameter smaller than the first ring and be supported for rotation about a y-axis that bisects the second ring. When in a home position, the y-axis can be oriented generally horizontally and width-wise relative to a base and permit for-and-aft pitch movement of a child seat.

In one example, rotational travel of a child seat on a development device about a y-axis, which in a home position is oriented generally horizontally and perpendicular to an x-axis can be limited to about 10 degrees or less in each direction from the home position.

In one example, a child seat of a development device can be suspended from a seat ring of a gimbal-like structure of a carrier. The seat ring can be oriented perpendicular or normal to and centered on a z-axis. When in a home position, the z-axis can be oriented generally vertically.

In one example, a development device can have a base that is configured to rest on a support surface and that can have a vertical portion. A carrier can be cantilevered extending from the vertical portion.

In one example, a development device can have a carrier coupled to a vertical portion of a base by a support arm configured to permit vertical reciprocal movement of the carrier.

In one example, a development device can have a seat ring connecting a child seat to a carrier ring of a gimbal-like structure. The seat ring can be rotatable concentric with and relative to the carrier ring.

In one example, a development device can have a carrier with a gimbal-like structure that can have a first ring of a first diameter supported for rotation about an x-axis that bisects the first ring. When in a home position, the x-axis can be oriented generally horizontally and lengthwise relative to a base and permit side-to-side roll movement of a child seat. A second ring can be supported by the first ring and have a diameter smaller than the first ring and be supported for rotation about a y-axis that bisects the second ring. When in a home position, the y-axis can be oriented generally horizontally, width-wise relative to the base and perpendicular to the x-axis and permit for-and-aft pitch movement of the child seat. A seat ring can be concentric with and carried by the second ring with the child seat supported by the seat ring for swiveling relative to the second ring about a z-axis. The seat ring and second ring can be oriented normal or perpendicular to and centered on the z-axis. When in a home position, the z-axis can be oriented generally vertically.

In one example, a development device has base, a carrier, and a child seat that can be foldable from an in-use configuration to a more compact folded configuration.

In one example, a juvenile product has a carrier coupled to the juvenile product and elevated above a support surface. The carrier can define an x-y-z axis system including a generally vertical z-axis, a generally horizontal x-axis and a generally horizontal y-axis oriented normal to the x-axis. A child seat can be coupled to the carrier and positionable such that feet of an occupant of the seat can contact a launching surface. The child seat can, relative to the juvenile product, independently rotate about the z-axis, rotate about the x-axis, and rotate about the y-axis. In one example, the launching surface can be either a surface on the juvenile product or a support surface on which the juvenile product rests.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of an development device for a child and constructed in accordance with the teachings of the present invention

FIG. 2 shows a partial exploded perspective view of the development device in FIG. 1.

FIG. 3 shows a top view of the development device, minus the child seat, in FIG. 2.

FIG. 4 shows a front view of the development device in FIG. 3.

FIG. 5 shows a side view of the development device in FIGS. 3 and 4.

FIG. 6 shows a perspective enlarged view of a support arm portion of the development device in FIGS. 1-3 and 5.

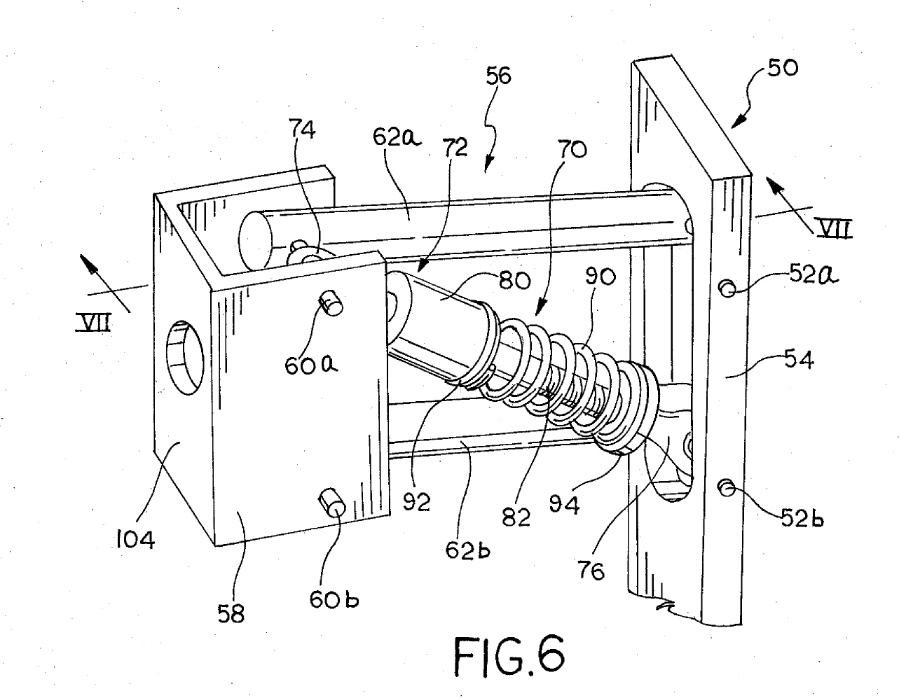

FIG. 7 shows a cross-section taken along line VII-VII in FIG. 3 of the support arm portion of the development device.

FIG. 8 shows the motion characteristics of the carrier and support arm portions of the development device in FIG. 1.

FIG. 9 shows a perspective view of a generic gimbal structure.

FIG. 10 shows a cross-section along line X-X of the development device in FIG. 1.

### DETAILED DESCRIPTION OF THE DISCLOSURE

The present invention is generally directed to development devices that solve or improve upon one or more of the above-noted and/or other problems and disadvantages with prior known such products. In one example, a development device as disclosed herein can provide a vertical bouncing motion characteristic for a child seated of the disclosed development device. In one example, the disclosed development device can allow a child to swivel or rotate about a generally vertical reference axis while seated in the child seat of the development device. In one example, the disclosed development device can allow a child to lean, bend, or pivot forward and backward about a generally horizontal reference axis while seated in the child seat of the development device. In one example, the disclosed development device can allow a child to bend, pivot, or lean from side to side about a generally horizontal reference axis while seated in the child seat of the development device. The disclosed development device helps to develop balance skills and core muscles of the child in a controller environment. In one example, the disclosed development device can allow a child to move in each of the above ways, independent of one another, while seated in the child seat of the development device.

In one example, a caregiver can adjust the motion characteristics and limits relative to any one or all of the above described movements appropriate to their particular child's needs. In one example, the development device can be provided with a book, pamphlet, or manual that helps define movement and resistance ranges, limits, and the like and defines age, height, and/or and weight appropriate movements and programs.

The disclosed child development device can, thus, impart developmentally appropriate resistance to a variety of muscle groups and body parts of the child. In this way, the disclosed development device can enhance development of a child's gross motor skills related to balance, muscle control, extremity control, and three dimensional movement in addition to those related to simply standing upright, jumping, or walking. Additionally, the limits, resistance, and degree of weight support provided by the development device can adjustable according to a child's needs. The disclosed development device is also equally well suited to the development of standing, jumping, and walking motor skills in comparison to the known products and devices. As a result, the disclosed development device can be configured to provide adequate support for a child seated in the development device while assisting the child in developing a range of gross motor skills during the pre-walking and early developmental walking age range. In one example, the disclosed development device may be directed to assisting in gross motor skill development for children in the 3 month to 2 year age range.

Although the disclosed example is described in connection with an activity center or entertainer, one or more aspects of the present disclosure can be incorporated into other child development devices or juvenile products. Many, if not all, of the aspects of the disclosure can be applied to products and devices such as, for example, bouncers, swings, walkers, doorway and other jumpers, stationary entertainers, playards, and the like. The disclosed development device could even be provided on a stroller to allow a child to learn balance while riding along. In this way, some products and devices constructed in accordance with the teachings of the present disclosure can be directed to targeting different age ranges and/or developmental skills. One or more aspects of the disclosed development device can be generally configured to assist in developing a variety of different movements, muscle groups, and motor skills to encourage a broad range of gross motor skill development.

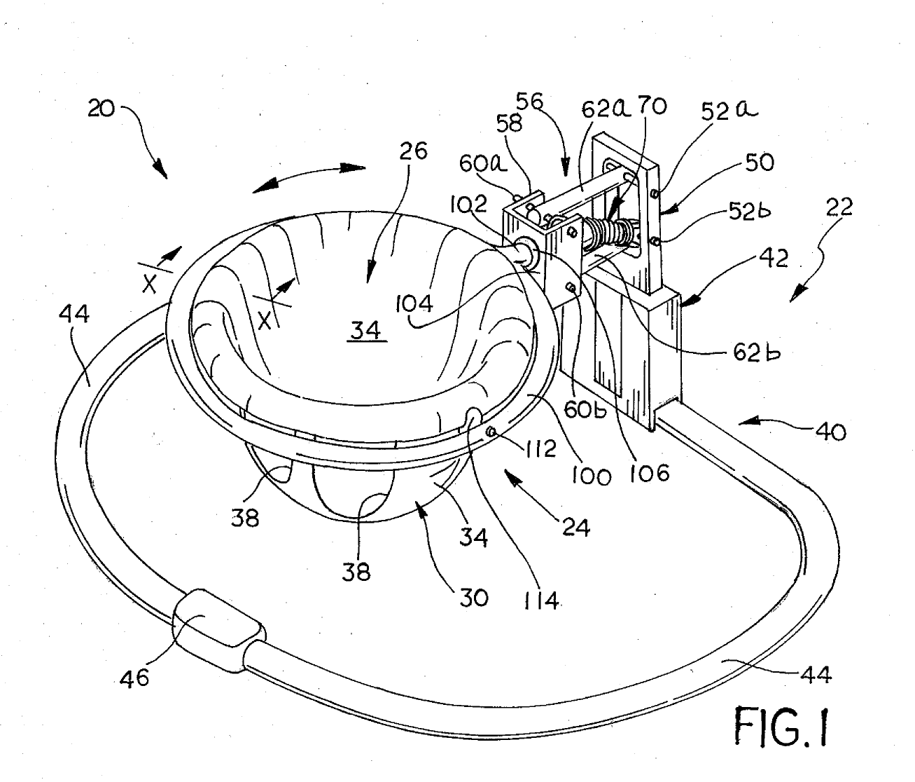

Turning now to the drawings, FIG. 1 generally shows a child's entertainer or activity center 20 as one example of a development device constructed in accordance with the teachings of the present invention. In this example, the activity center 20 generally has a base 22 configured to rest on a support or ground surface and a carrier 24 coupled to the base and elevated above the ground surface. In general, the carrier 24 defines an x-y-z axis system that can move relative to a reference x-y-z axis system for a child seated in the activity center 20. The x-y-z axis system is described later with respect to several of the figures. The activity center 20 also has a child seat 26 that is coupled to the carrier and that can, relative to the base 22, independently swivel or rotate about a reference z-axis, rotate about a reference x-axis, and rotate about a reference y-axis. However, the motion characteristics of the carrier and, thus, the child seat are more complex, as is described below.

In other examples, the development device can be utilized on other juvenile products aside from activity centers and entertainers. The base can be the juvenile product or a frame or other component of such a product that supports the carrier and/or seat. The development device, or at least aspects of the device, can be incorporated into a stroller, playard, swing, or other type of juvenile product. The base can rest either on the ground or support surface, or can rest on or be a part of another portion of the product. In each example, a child occupant that is seated in the child seat should be able to touch a surface with their feet in order to control their motions. This surface is identified herein as the launching surface. The launching surface can be the ground or support surface on which the development device rests or can be another surface or object of the juvenile product. For example, if the development device were incorporated into a playard, the launching surface could be the bottom play or sleep surface of the playard. The base of the development device could be considered as the entire playard, the playard frame, or the like. In another example, the cantilever style base 22 disclosed herein could be replaced by a three-legged or four-legged base or other type of base.

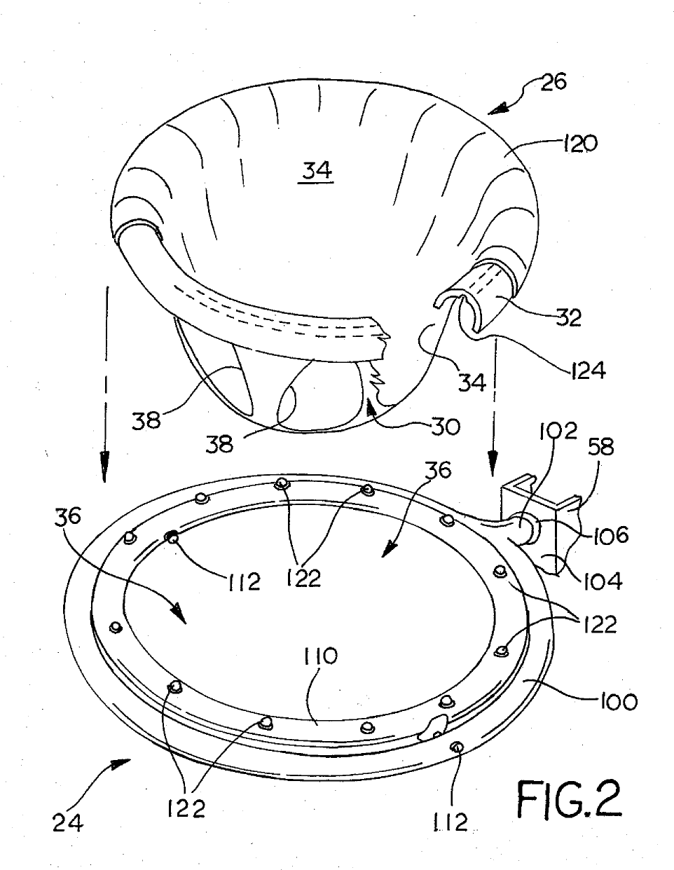

As shown in FIGS. 1 and 2, the child seat 26 generally includes a sling-type fabric support 30 suspended from a seat ring 32 that is mounted to a part of the carrier 24 in this example. The fabric support 30 has a side wall 34 that is coupled at its upper end to the seat ring 32 such that the side wall 34 depends from an interior opening 36 in the seat ring 32. In this example, the fabric support 30 has a pair of leg openings 38 as is known in the art for allowing a child's legs to extend through the fabric support and downward toward the ground or support surface.

With reference to FIGS. 1-3, the base 22 generally has a support frame 40 and an upright portion, spine, or post 42 that is connected to and extends upward from the support frame. The support frame 40 is generally configured to rest on a ground or support surface to provide a stable resting base for the activity center 20 in this example. As will become evident to those having ordinary skill in the art upon reading this disclosure, the configuration and construction of the base 22 and the support frame 40 can vary considerably within the spirit and scope of the present invention. In one example, the device 20 may be configured so that a child can “walk” the seat 360° around a portion of the base or frame. The base 22 in such an example should be sufficiently sized and stable enough to safely allow such movement.

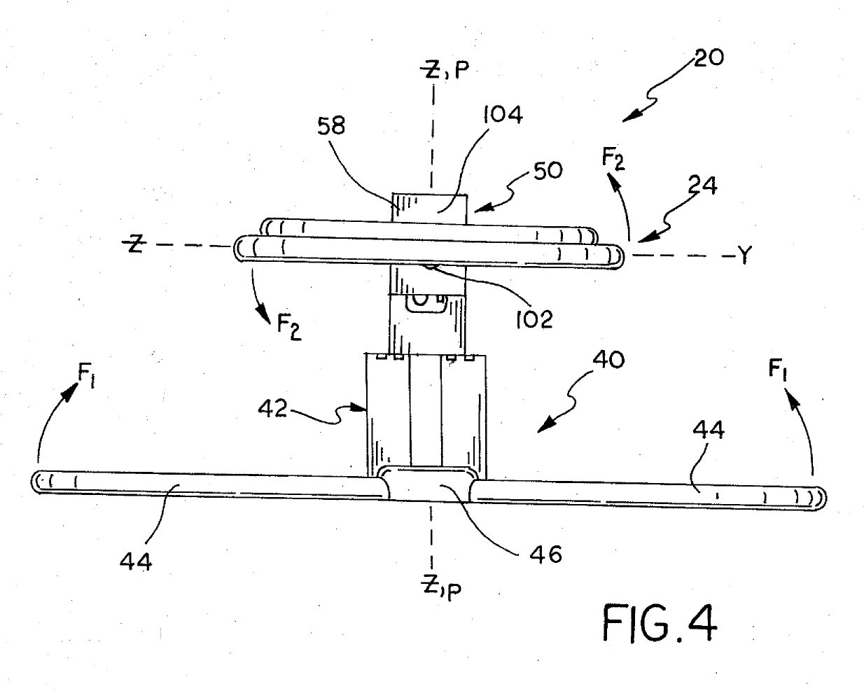

In this example, the support frame 40 has two mirror image frame sections 44. The frame sections 44 at their respective first ends are connected to the spine 42 and at their respective other ends are connected or joined to one another at a joint 46. As depicted in FIG. 4 by the arrows F1 and F2, the frame sections 44 can be configured to fold upward or downward relative to one another and toward or onto one another to create a compact frame configuration. Likewise, the carrier 24 can be rotatable to a folded orientation with the folded frame sections 44, if desired. The folded configuration of the development device or activity center 20 in this example can be suited for easily storing or transporting the activity center, if needed. The frame sections 44 can be pivotally connected at the joint 46 and at their respective connection points to the spine connections 42 in order to permit such folding. The carrier 24 can be pivotally connected to the base 22 in a manner permitting such folding or rotation for storage. In this example, the frame section 44 and the carrier 24 can be configured to fold up generally parallel with one another and with the z-axis, along with part of the base 22.

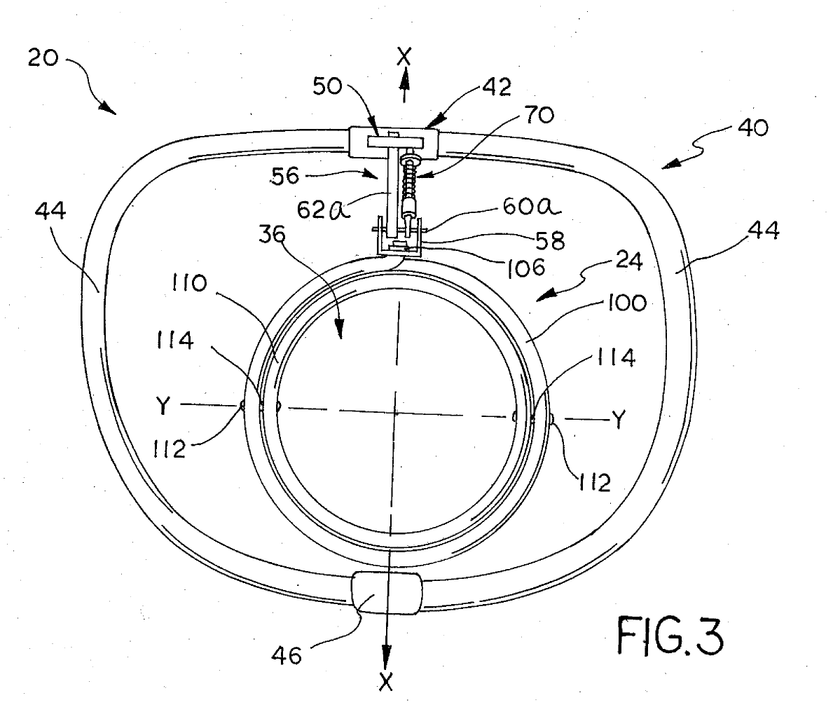

In the disclosed example, the frame sections 44 of the support frame 40 together define a D-shaped structure when viewed from the top, as shown in FIG. 3. The frame sections 44 can take on other configurations and constructions and yet function as intended to provide a stable base for the activity center 20. In other examples, the base 22 can be configured as a single structure instead of from two or more separate frame sections. Alternatively, the support frame 40 can be configured having other shapes different from the D-shape shown herein. For example, the support frame 40 can be an oval shape, circular, X-shaped, or the like and yet function as intended. In addition, the materials and structure of the various components used to fabricate the support frame 40 can vary within the spirit and scope of the invention. For example, the frame sections can be formed from aluminum or steel tubing or other such metals, or from plastics or composites that provide adequate strength and stability. Other suitable materials and structural configurations can also be utilized.

With reference to FIGS. 1-4, the spine 42 is connected to a portion of the support frame 40 and projects generally vertically upward relative to the support or ground surface and frame. The spine can take on any number of configurations and constructions within the spirit and scope of the present invention. The spine can also include a decorative cover (not shown herein) to present a more aesthetically pleasing design and to cover internal moving parts of the activity center 20 for safety reasons and improved appearance. The cover can also provide controls for features of the device such as lights and sound used to entertain or sooth. In this example, the spine 42 has an upper section 50 with a pair of horizontal axles that define a pair of pivot axes 52a, 52b. The axles are vertically spaced apart from one another on the spine 42 and extend between a pair of vertical stanchions 54 of the upper section 50. In this example, the spine 42 is physically fixed to the support frame 40 and the pivot axes 52A, 52B are also physically fixed in position.

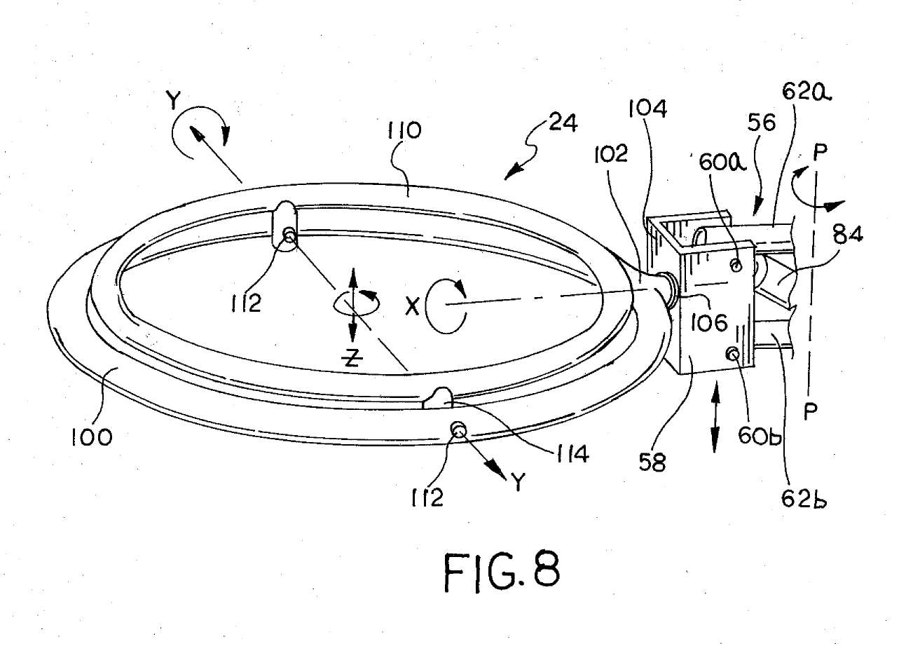

In an alternate example, as described in greater detail below, the spine 42, or at least the upper section 50 thereof, can be configured so as to permit rotary reciprocation of the carrier 24 about a vertical axis of the spine. The carrier can be configured to reciprocate within a defined travel arc or, as noted above, to allow rotation through 360° about the spine axis. If rotation about the spine or base axis is to be limited, hard stops can be provided at the pivot joint. These hard stops can be provided on a motion restrictor (see FIG. 8 and discussion below), if desired, that permits a caregiver to manual adjust how far or through what angle the carrier is permitted to rotate about the spine or base axis. The motion restrictor can also be capable of adjusting the rotation resistance and thus the force required to rotate the carrier around the spine or base axis. Such motion characteristics can add an additional degree of freedom of motion to the activity center.

With reference to FIGS. 1-3 and 5, the activity center 20 has a support arm 56 connecting the carrier 24 to a portion of the base or the activity center. In this example, the support arm 56 is cantilevered from a portion of the base or activity center, and in particular is cantilevered from the spine 42. As illustrated, the carrier 24 is thus cantilevered from the spine 42 above the ground and over the support frame 40 in this example. The support arm 56 is connected at one end to the upper section 50 of the spine 42 and is connected at its other end to the carrier 24. As will become evident to those having ordinary skill in the art upon reading this disclosure, the support arm 56 can also vary in configuration and construction within the spirit and scope of the invention. In this example, the support arm 56 is configured to allow a vertical bouncing or reciprocating motion at the end coupled to the carrier 24, thus allowing the carrier to move or reciprocate vertically.

In the disclosed example, the support arm 56 has a four-bar linkage structure. A carrier coupling 58 connects the carrier 24 to the free end of the support arm 56. The carrier coupling 58 has a vertical dimension and also has a pair of axles that define a pair of horizontal pivot axes 60a, 60b. In this example, the pivot axes 60a, 60b are vertically spaced apart on the coupling 58 at about the same distance as the pivot axes 52a, 52b. However, the two axle pairs, and thus the two pairs of axes can be spaced differently relative to one another in order to impart different motion characteristics to the support arm, as desired. Alternatively, the support arm 56 can vary in configuration and construction and not include a four-bar linkage structure and yet can allow for vertical motion.

In this example, the support arm 56 has a pair of links 62a and 62 that are vertically spaced apart and oriented somewhat horizontally. The upper link 62a has one end connected to the upper pivot axis 60a on the carrier coupling 58 and an opposite end connected to the upper pivot axis 52a on the upper section 50 of the spine 42. Likewise, the lower link 62b has one end pivotally coupled to the lower pivot axis 60b on the carrier coupling 58 and its other end pivotally coupled to the lower pivot axis 52b on the spine's upper section 50. The four-bar linkage structure is defined by the upper and lower links 62a, 62b, the carrier coupling 58 at one end between the pivot axis 60a and 60b, and the stanchions 54 on the spine's upper section 50 at the other end between the pivot axis 52a and 52b. The four-bar linkage structure allows vertical pivoting movement of the support arm such that the carrier coupling 58, and thus the carrier 24, on the free end of the support arm 56 can move upward and downward relative to the support frame 40 and the ground. The pivot axes 52a, 52b, 60a, 60b can include bearings or bearing structures (not shown) to provide for smooth and consistent motion characteristics and feedback.

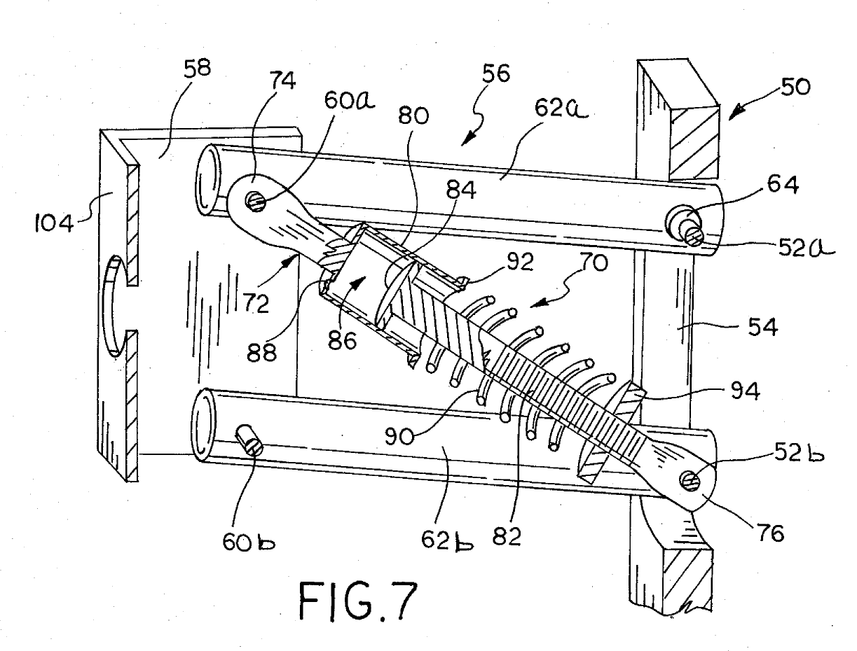

If the range of vertical motion of the carrier relative to the base 22 is to be limited, hard stops can again be provided at one of the pivot joints. These hard stops can also be provided by a motion restrictor 64 mounted to one of the pivot axes such as the pivot axis 52b as in FIG. 7, if desired. The motion restrictor 64 can permit manual adjustment by a caregiver to limit the travel range, the minimum travel height, and/or the maximum travel height of the carrier. The motion restrictor 64 can also be capable of adjusting the rotation resistance and thus the force required to move the carrier up and down.

Instead of or in addition to the motion restrictor 64, an adjustable spring mechanism can be utilized as a motion restrictor to help control the vertical motion characteristics, if any, for the device. In this example, a turnbuckle-like spring mechanism 70 is coupled to the support arm 56 and performs several functions. One of the functions can be to adjust and set or control the vertical resting position of the carrier end or free end of the support arm 56. Another function of the spring mechanism 70 can be to impart a vertical bounding characteristic to the motion of the activity center 20. Yet another function of the spring mechanism 70 can be to dampen the bouncing motion. Still another function can be to counter the weight of a child seated in the seat so as to impart a similar bouncing motion to different sized children or to partially or complete support the weight of a child, if desired. The spring mechanism 70 in this example allows the activity center 20 to be adjusted to accommodate children within a range of sizes and weights.

In this example, the spring mechanism 70 employs a multi-stage connector link 72 that bisects the four-bar linkage structure of the support arm 56. One end 74 of the connector link 72 is pivotally connected to the axle of the upper pivot axis 60a on the carrier coupling 58. The other end 76 of the connector link 72 is pivotally coupled to an axle of the pivot axis 52b on the spine's upper section 50. The one end 74 of the connector link 72 has an open ended piston housing 80 connected thereto. The other end 76 of the connector link 72 has a threaded shaft 82 extending from the other end and terminating at a piston head 84. The piston head 84 is received within the piston housing 80 and creates a piston chamber 86 therein between the head and a closed end of the housing. A vent 88 can be provided through the piston housing 80 to the piston chamber 86 to determine the dampening effect of the piston as is known in the art. A bleed valve (not shown herein) can be provided at the vent 88 to adjust the dampening effect of the piston.

A coil spring 90 is received over the shaft 82 on the link 72. One end of the spring 90 bears against a spring flange or shoulder 92 on the open end of the piston housing 80. An opposite end of the spring 90 bears against a threaded collar 94 that is adjustable along and received on the threaded shaft 82. The threaded collar 94 can be positionally adjusted along the shaft 82 to alter the spring length. Thus, the spring force applied via the spring 90 to the opposite corners of the support arm 56 can be adjusted, which may adjust the vertical at-rest position of the support arm and alter the bounce characteristics by adding friction to the pivot axes.

With reference to FIGS. 1-5, 8, and 9, the carrier 24 in the disclosed example is configured to permit the child seat 26 to move relative to each axis of an x-y-z axis system. In particular, the carrier 24 generally has a gimbal-like structure in this example. The gimbal-like structure of the carrier 24 has a first ring 100 that has a circular configuration. The ring 100 has a first diameter and a stub 102 projecting radially outward from a side of the ring. The stub 102 is pivotally mounted to a face plate 104 of the carrier coupling 58. A bearing device (not shown) and/or a motion restrictor 106 can be provided at the connection between the carrier coupling 58 and the stub 102 of the first ring 100. The bearing device can be configured to allow for smooth rotation or pivoting motion of the first ring 100 relative to the face plate 104 on the carrier coupling 58. The bearing device can also be configured to structurally support the first ring 100 in a cantilevered arrangement from the support arm 56. If rotation of the first ring 100 about the x-axis is to be limited, hard stops can be provided at the pivot joint of the stub 102. These hard stops can be provided on the motion restrictor 106, if desired. The motion restrictor 106 can permit a caregiver to manually adjust how much rotation is permitted about the x-axis. The motion restrictor 106 can also be capable of adjusting the rotation resistance and thus the force required to rotate the first ring 100 about the x-axis.

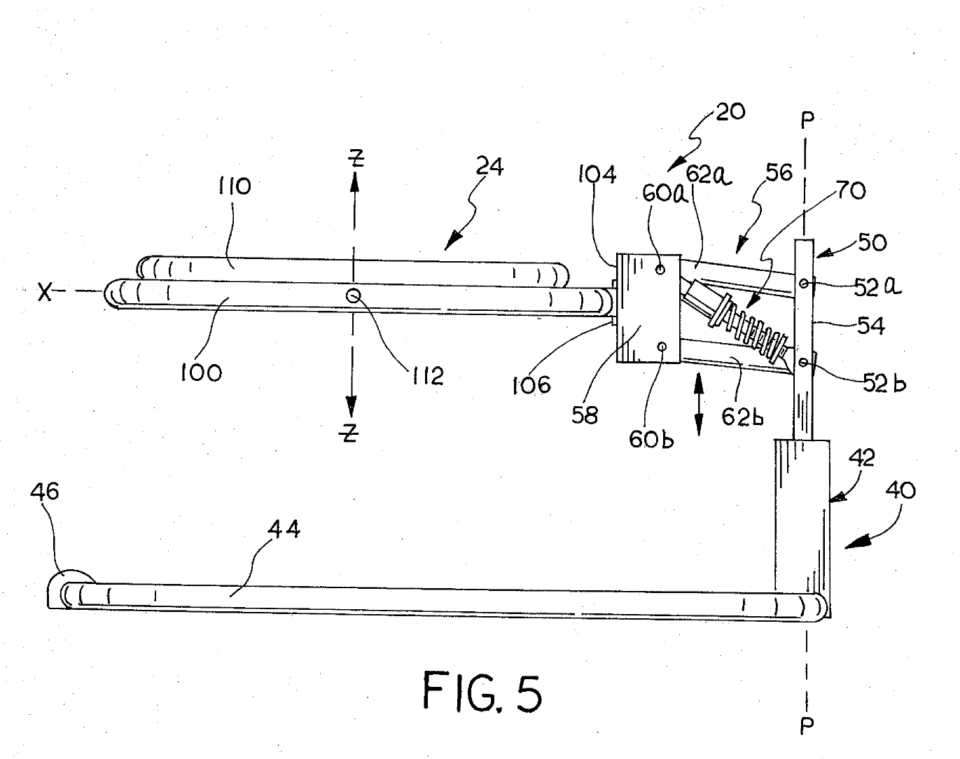

In this example, a reference x-axis is generally horizontally oriented and generally parallel to the support frame 40 and the ground. The x-axis extends lengthwise relative to the activity center 20 along the support arm 56, through the bearing device 106, and bisects the first ring 100, as depicted in FIG. 3. The first ring 100 can rotate or pivot about the reference axis. In a home position as illustrated in FIGS. 4 and 5, the first ring 100 lies in a generally horizontal first ring plane. However, depending on the support arm position both at rest and during vertical oscillation, the relative orientation of both the x-axis and the first ring plane can vary from a true horizontal reference, such as one defined by the ground or support frame 40. Thus, the term “generally” is used herein to note that the x-axis and first ring plane may not be exactly horizontal, even in the home position.

The carrier 24 also has a second ring 110 that is pivotally connected to and supported by the first ring 100 is this example. The second ring 110 also has a circular configuration in this example and is arranged concentric with the first ring 100. The second ring 110 has a diameter that is smaller than that of the first ring 100 and that is supported for rotation about a reference y-axis that bisects the first and second rings. The y-axis in a home position is oriented generally horizontally relative to the support frame 40 and the ground, but is normal or perpendicular to the x-axis. Thus, the y-axis is oriented width-wise relative to the base as depicted in FIG. 3. In the home position as illustrated in FIGS. 4 and 5, the second ring 110 also lies in a generally horizontal second ring plane that is parallel to, but spaced above, the first ring plane of the first ring 100. Again, depending on the orientation of the first ring 100 and the x-axis, the relative orientation of both the y-axis and the second ring plane can vary from a true horizontal reference, such as one defined by the ground or support frame 40. Thus, the term “generally” is also used herein to note that the y-axis and second ring plane may not be exactly horizontal, even in the home position.

A pair of pivots 112 is located on opposite sides of the second ring 110 and pivotally connects the second ring to the first ring 100. The pivots 112 define and are aligned with the y-axis. In one example, the pivots 112 can include bearing devices (not shown) to allow for smooth and consistent rotation of the second ring 110 about the pivots 112 relative to the first ring 100. One or both of the pivots 112 can also or instead include a motion restrictor 114. If rotation of the second ring 110 about the y-axis is to be limited, hard stops can again be provided at the pivots 112. These hard stops can be provided on the motion restrictor 114, if desired. Again, the motion restrictors 114 can be configured to permit a caregiver to manually adjust how much rotation is permitted about the y-axis. The motion restrictors 114 can also be capable of adjusting the rotation resistance and thus the force required to rotate the second ring 110 about the y-axis.

In one example, the motion restrictors 106 and 114 or other such structures and components can be configured to limit the range of motion, i.e. the permissible rotation angle, of each of the rings 100 and 110 to a fixed angular travel limit. In another example, the motion restrictors 106, 114 can permit adjustment of the range of motion for each of the rings. In the disclosed example, the stub 102 and the pivots 112, as well as the motion restrictors 106, 114, can permit unlimited rotary travel, like a gimbal. It is possible that the weight of an infant or child supported by the fabric sling 30 could be relied on to prevent over-rotation of either of the rings. An infant may not be capable of readily rotating one of the rings 100, 110 far enough so as to achieve an angle where the child would not be able to support their own head or invert the child seat 26 and risk having the child fall from the seat. Very young infants may be susceptible to asphyxia if they reach an orientation while somewhat upright where they cannot support their head. Thus, some type of range of motion restriction can be employed to reduce or prevent the likelihood of these situations occurring. For example, hard stops can be employed to prevent rotation beyond a predetermined maximum angle whereas motion restrictors can be employed that allow for adjustment within the maximum range.

A vertical reference z-axis in this example is centered on the first and second rings 100, 110 as shown in FIG. 3. The z-axis is oriented generally vertically relative to the support frame 40 and the ground and normal or perpendicular relative to the x-axis, the y-axis, and an x-y plane defined by those two axes. The z-axis is depicted in FIGS. 4 and 5 when in a home position as being oriented generally vertically relative to the support frame 40 and the ground, and as being generally normal or perpendicular to both the x- and y-axes and to both the first and second ring planes. Again, depending on the orientation of the first ring 100 and the x-axis, and the second ring 110 and the y-axis, the relative orientation of the z-axis can vary from a true vertical reference, such as one perpendicular to the ground or support frame 40. Thus, the term “generally” is also used herein to note that the z-axis may not be exactly vertical, even in the home position.

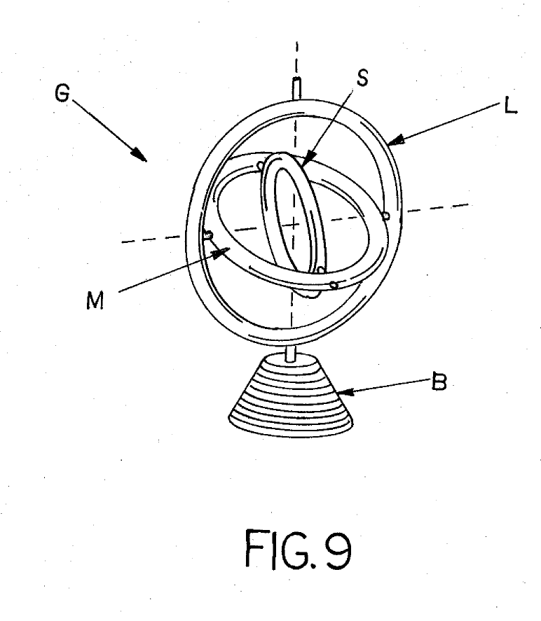

With reference to FIG. 8, the gimbal-like structure of the carrier 26 permits independent movement relative to each of the x-axis, y-axis, and z-axis. However, the motions are not completely independent. FIG. 9 shows a conventional gimbal G, which has a large ring L supported for rotation about a vertical z-axis on a base B. A medium-sized ring M is supported for rotation on an x-axis within the large ring L, with the x-axis being perpendicular to the z-axis. A smaller sized ring S is supported for rotation on a y-axis within the medium ring M, with the y-axis being perpendicular to both the other two axes. In the disclosed example, a child seated in the child seat 26 can move somewhat independently relative to each of the axes, similar to a gimbal. Thus, the use of the term “gimbal-like” with reference to the carrier structure disclosed and described herein. A child seated in the child seat 26 can pivot or rotate the first ring 100 side-to-side about the x-axis independent of the other two axes. With reference to the child, this motion can simulate a roll-type or side-to-side motion. A child seated in the seat can also independently pivot or rotate the second ring 110 forward and rearward about the y-axis. With reference to the child, this motion can simulate a pitch-type or fore-and-aft motion. A child seated in the seat can also independently swivel the child seat 26 within the carrier 24, as described below, about the z-axis. With reference to the child, this motion can simulate a yaw-type or swivel motion. Lock-offs can be optionally provided in order for caregiver to opt to prevent rotation about any one of the axes. The lock-off feature can be incorporated into the various motion restrictors noted herein.

As described earlier, and in addition to movement relative to the x-y-z reference axis system, the support arm 56 in this example is constructed to also permit vertical bouncing motion imparted by the child to the carrier 24. Thus, the entire reference axis system can move upward and downward along the z-axis. The spring mechanism 90 in this example is configured to enhance the bouncing characteristics of this motion. In addition to these four types of motion, a fifth motion characteristic can be built into the activity center 20. As shown schematically in FIG. 8, the support arm 56 can be coupled to a part of the base, such as the spine 42, so that the carrier 24 can rotate completely around or partly around, through a generally horizontal arc of a circle segment, a vertical base axis P, in this case a vertical base or spine axis defined by the spine. This reciprocal swaying or swinging motion through a partial orbit about the axis P can also be built into the activity center 20, if desired.

As the child moves, the orientation of the various axes can change relative to the home position, similar to the gimbal G of FIG. 9. The gimbal-like structure of the carrier 24 allows for such movements. In one example (not shown), the child seat 26 could be pivotally mounted to the second ring 110 similar to the manner in which the second ring is mounted to the first ring 100. Such a construction would simulate a true gimbal G structure and allow similar freedom of movement. With such a construction, the motion of the child could be defined using what are known as Tate-Bryan angles, which are a specific form of Euler angles as used in the aerospace industry. Thus, the motion of the child seated in the child seat would simulate the role-pitch-yaw type movement noted above. Yaw, pitch and roll are used in aerospace to define a rotation between a reference axis system and a vehicle-fixed axis system, i.e., from the child seat occupant's point of view in this example.

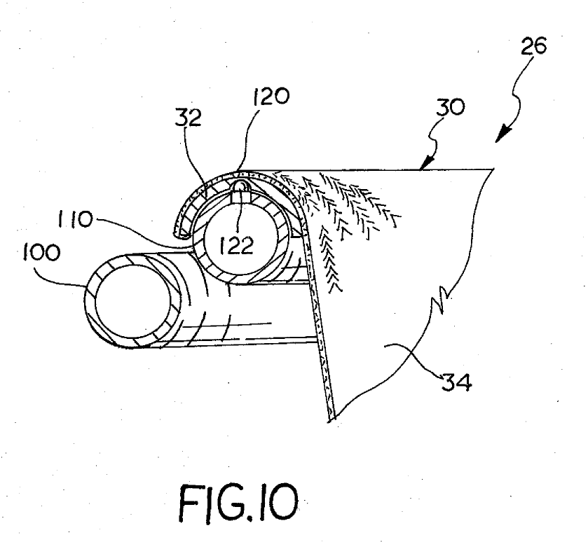

However, the seat ring 32 in this example, as can be seen in FIGS. 2 and 10, is mounted concentric with and onto the top of the second ring 110. In this example, the seat ring has an inverted U-shaped cross-section configured to seat on top of the second ring 110. Thus, the seat ring 32 has the same diameter as the second ring 110. An upper edge 120 of the fabric sling 30 can be attached to and draped over the top of the seat ring 32 so that the side walls 34 of the swing hanging or are suspended from the interior opening of the seat ring. The seat ring 32 is configured so that it can rotate around the circumference of the second ring 110 in this example. A plurality of ball bearings 122 can be provided facing upward on the second ring 110. A bearing track or race 124 can be formed on the underside of the seat ring 32 and positioned so that the ball bearings seat in the track or race. Other examples of a seat ring structure are within the spirit and scope of the present invention, and particularly means and methods by which the seat ring is made capable of rotation about the circumference of the second ring 110.

In this example, the seat ring 32, and thus the child seat 26, can rotate about the z-axis independent of movement about the other axes. However, a plane of the seat ring will move in concert with the second ring 110. In the true gimbal structure shown in FIG. 9, the small ring S would equate to the second ring 110, the medium ring M would equate to the first ring 100, and the large ring L would equate to the motion of the seat ring 32. The carrier 24 produces slightly different overall motion characteristics in comparison to a true gimbal because the seat and 32 is carried on second ring 110 in this example. As the second ring 110 is tilted about y-axis, the seat ring 32 will also tilt. Hence, the structure of the carrier 24 is described herein as gimbal-like instead of exactly simulating a gimbal structure as depicted in FIG. 9.

The seat ring 32 shown in FIGS. 2 and 10 can be expanded radially in order to carry toys or other entertainment devices. In addition, the toys can include one or more that make noise. The toys can be configured so as to require a child to move in order to access the toy, aiding in the physical and gross motor development of the child. Sounds can be produced that will gain the attention of a child and require the child to move in order to determine the source of the sound, again aiding in the child's gross motor and physical development. A combination of toys and sound can be employed to do the same. Sounds and toys can even be choreographed to elicit specific movements of the child to further enhance their overall development. The toys can be sized and placed so as to encourage gross motor skill development of the child's core muscles upper body strength and control, arm and hand coordination, and head and neck control.

The seat ring 32 can be part of the carrier 24 or the child seat 26, depending upon the particular construction of both components. In this example, the seat ring 32 is defined as part of the overall carrier 24 and, thus, the gimbal-like structure, because the seat ring allows rotation of the child seat 26 relative to the z-axis. However, the seat ring 32 is coupled to the fabric sling 30 and can easily be described as a part of the child seat 26 instead. The carrier 24 can also readily be described as including child seat 26 in this example.

In the disclosed example, the rotation of the seat ring 32 is independent of the seat ring 110. Thus, the x-axis and y-axis, and the x-y plane defined thereby, do not rotate as the seat ring 32 rotates. Depending on the orientation of the child and the child seat 26, the child might not be able to lean directly forward or rearward or from side-to-side and at some point the first ring 100 would provide the pitch-type motion and the second ring 110 would provide the roll-type motion from the child's reference. In another alternative example, though not shown or described in any detail herein, the carrier 24 can be constructed such that as a child rotates the child seat 26 and seat ring 32, at least the second ring 110, or both the first and second rings 100 and 110, rotates therewith. This would rotate the x-axis and y-axis within the x-y plane. In such an example, regardless of the orientation of the seat ring 32 and child seat 26, a child could be able to lean forward or rearward to change their pitch angle and could be able to lean side to side to change their roll angle. Such motion characteristics would more closely simulate the roll-pitch-yaw type movements described above.

As noted above, the movement about at least the x-axis and y-axis can be travel limited. In one example, rotation of the first ring 100 can be limited to a roll angle of about 10° or less in each direction (20° total) from the home position. In one example, rotation of the second ring 110 can be limited to a pitch angle of about 10° or less in each direction (20° total) from the home position. If desired, rotation of the seat ring 32 about the second ring 110 can be limited as well by providing travel stops (not shown) desired positions at the interface between the two rings. Multiple optionally selectable travel stops can also be employed, as well as a lock-off feature, to permit a caregiver to limit, adjust, or prevent rotation of the seat ring 32. Adjustable rotation resistance can also be employed between the seat ring 32 and second ring 110 to allow a caregiver to change how easy or difficult is to rotate the seat ring about the second ring. Rotation of the first and second rings and the seat ring can be limited by providing travel limiting features within the motion restrictors 106, 114, the stub 102, the faceplate 104, the pivots 112, the pivot axis P, the pivot axes 52a, 52b, 60a, 60b, the seat ring 32, or the like.

The motion restriction mechanisms, devices, and methods can vary within the scope of the invention. Many such devices and techniques are known and commercially available. Range of motion limiters, linear travel limiters, rotation limiters, friction adjusters, and the like are known. One such device might employ a spring between two plates, one carried on each of the two parts rotating relative to one another. The plate spacing can be adjusted via a set screw to change the applied spring force on the plates and thus increase or decrease rotation friction. Complimentary stops on the plates can be positionally adjustable to set and alter the permissible range of motion. Other techniques and devices are known and within the purview of the disclosed motion restrictors and methods.

The disclosed activity center 20 permits a child seated within the child seat 26 can move relatively independently about multiple axes. Complex motion characteristics for the child can be achieved, as the child is not limited to just vertical jumping or bouncing or swiveling motions. In the disclosed example, the child can lean forward or back freely as permitted by the second ring 110. A child can also lean from side to side freely as permitted by the first ring 100. The child can further swivel within the carrier structure 24 as permitted by the free rotation of the seat ring 32 about the second ring 110. If provided, the four-bar linkage structure of the support arm 56 can also permit the child to bounce or jump all supported by the child seat 26. Also if provided, the lateral swaying or orbiting motion about the spine axis P can also permit a child to walk or jump from side-to-side, moving the entire carrier 24 through a partial orbit about the spine axis. These various motion characteristics imparted by a child can enhance gross motor skill development in the child. A child can become more in tune with their body's center of gravity and can improve their balance and muscle development while seated in the child seat 26 of the activity center 20.

It is conceivable that the first ring 100, the second ring 110, and the seat ring 32 can each be provided as a part of the carrier 24 without the other components. It is possible that other structures and components can be configured to pivotally or rotationally support any one of the first ring 100, the second ring 110, and seat ring 32 as described herein without the presence of the other two components. The angular travel of the first and second rings can be limited to different angles, such as 5° in each direction or 10° total. The travel limits of the various moving components can be selectively adjustable or restricted independent of the movement of other components or can be linked so that adjustment of one movement also adjusts another movement of the development device.

Although certain development devices for children have been disclosed and described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A development device for physical and gross motor development of a child, the development device comprising:
a base;
a carrier coupled to the base and elevated above a support surface, the carrier defining an x-y-z axis system including a generally vertical z-axis, a generally horizontal x-axis and a generally horizontal y-axis oriented normal to the x-axis; and
a child seat that is coupled to the carrier and that can, relative to the base, independently rotate about the z-axis, rotate about the x-axis, and rotate about the y-axis.

2. A development device according to claim 1, wherein when the child seat rotates about the z-axis, an x-y plane defined by the x-axis and y-axis does not rotate about the z-axis.

3. A development device according to claim 1, wherein when the child seat rotates about the z-axis, an x-y plane defined by the x-axis and y-axis also rotates about the z-axis with the child seat rendering the z-axis rotation a yaw motion, the x-axis rotation a pitch motion, and the y-axis rotation a roll motion relative to the child seat.

4. A development device according to claim 1, further comprising:
one or more motion restrictors configured to permit selective adjustment of a rotational travel limit of the child seat, of a rotation resistance of the child seat, or both about one or more of the x-, y-, and z-axes.

5. A development device according to claim 1, further comprising:
a support arm cantilevered at one end from a portion of the base, the carrier coupled to another end of the support arm opposite the one end and above the base, and the base being configured to rest on the support surface.

6. A development device according to claim 5, wherein the one end of the support arm is pivotally coupled to the portion of the base at a base axis that is oriented generally vertically such that the support arm and the carrier can rotate around and relative to the base axis.

7. A development device according to claim 6, further comprising:
a motion restrictor configured to permit selective adjustment of a rotational travel limit of the support arm, of a rotation resistance of the support arm, or both about the base axis.

8. A development device according to claim 5, wherein the support arm and the carrier can reciprocally move in a generally vertical direction relative to the base.

9. A development device according to claim 1, wherein the carrier can reciprocally move in a generally vertical direction relative to the base.

10. A development device according to claim 9, further comprising:
a motion restrictor configured to permit selective adjustment of a vertical travel limit of the carrier, of a vertical motion resistance of the carrier, or both relative to the base.

11. A development device according to claim 1, further comprising:
a four-bar linkage cantilevered at one end from an upright portion of the base, the carrier suspended from another end of the four-bar linkage opposite the one end, the four bar-linkage arranged to allow the carrier to reciprocate vertically, and the base configured to rest on the support surface; and
a spring mechanism coupled to the four-bar linkage configured to render adjustable a vertical travel limit and the resistance to vertical reciprocation.

12. A development device according to claim 11, wherein the one end of the four-bar linkage is pivotally coupled to the upright portion of the base at a base axis that is oriented generally vertically such that the four-bar linkage and the carrier can rotate about the base axis relative to the base.

13. A development device according to claim 11, wherein a force applied by the spring mechanism is adjustable to offset the weight within a predetermined weight range of a child occupying the child seat.

14. A development device for physical and gross motor development of a child, the development device comprising:
a base;
a carrier coupled to the base and elevated above a support surface, the carrier having a gimbal-like structure defining an x-y-z axis system; and
a child seat suspended from the carrier and able to rotate about each of the x, y, and z axes independent of the other of the x, y, and z axes.

15. A development device according to claim 14, wherein rotational travel of the child seat relative to at least the x-axis and the y-axis is limited to about 10 degrees or less in each direction from a home position of the child seat with respect to each of the x- and y-axes.

16. A development device according to claim 15, further comprising:
an adjustable motion restrictor for each of the x-axis, y-axis, and z-axis that each permit a rotational range limit, a resistance to rotation, or both of the child seat relative to each axis to be independently adjusted.

17. A development device according to claim 14, wherein the gimbal-like structure of the carrier includes a first ring of a first diameter supported for rotation about the x-axis that bisects the first ring, and wherein, when in a home position, the x-axis is oriented generally horizontally and lengthwise relative to the base and permits side-to-side roll movement of the child seat.

18. A development device according to claim 17, wherein rotational travel of the child seat about the x-axis, which in a home position is oriented generally horizontally and perpendicular to the y-axis, is limited to about 10 degrees or less in each direction from the home position.

19. A development device according to claim 14, wherein the gimbal-like structure of the carrier has a second ring supported by a first ring, the second ring having a diameter smaller than the first ring, the second ring being supported for rotation about the y-axis that bisects the second ring and wherein, when in a home position, the y-axis is oriented generally horizontally and width-wise relative to the base and permits for-and-aft pitch movement of the child seat.

20. A development device according to claim 19, wherein rotational travel of the child seat about the y-axis, which in a home position is oriented generally horizontally and perpendicular to the x-axis, is limited to about 10 degrees or less in each direction from the home position.

21. A development device according to claim 14, wherein the child seat is suspended from a seat ring of the gimbal-like structure of the carrier, the seat ring being oriented normal to and centered on the z-axis, and wherein, when in a home position, the z-axis is oriented generally vertically.

22. A development device according to claim 14, wherein the base is configured to rest on the support surface and has a vertical portion and wherein the carrier is cantilevered extending from the vertical portion.

23. A development device according to claim 22, wherein the carrier is coupled to the vertical portion of the base by a support arm configured to permit vertical reciprocal movement of the carrier.

24. A development device according to claim 14, further comprising:
a seat ring connecting the child seat to a carrier ring of the gimbal-like structure, the seat ring rotatable concentric with and relative to the carrier ring.

25. A development device according to claim 14, wherein the gimbal-like structure comprises:
a first ring of a first diameter supported for rotation about the x-axis that bisects the first ring, wherein, when in a home position, the x-axis is oriented generally horizontally and lengthwise relative to the base and permits side-to-side roll movement of the child seat;
a second ring supported by the first ring, the second ring having a diameter smaller than the first ring and being supported for rotation about the y-axis that bisects the second ring, wherein, when in a home position, the y-axis is oriented generally horizontally, width-wise relative to the base, and perpendicular to the x-axis and permits for-and-aft pitch movement of the child seat; and
a seat ring concentric with and carried by the second ring, the child seat supported by the seat ring for swiveling relative to the second ring about the z-axis, the seat ring and second ring being oriented perpendicular to and centered on the z-axis, and wherein, when in a home position, the z-axis is oriented generally vertically.

26. A development device according to claim 14, wherein the base, the carrier, and the child seat are foldable from an in-use configuration to a more compact folded configuration.

27. A juvenile product comprising:
a carrier coupled to the juvenile product and elevated above a support surface, the carrier defining an x-y-z axis system including a generally vertical z-axis, a generally horizontal x-axis and a generally horizontal y-axis oriented normal to the x-axis; and
a child seat that is coupled to the carrier and positionable such that feet of an occupant of the seat can contact a launching surface,
wherein the child seat can, relative to the juvenile product, independently rotate about the z-axis, rotate about the x-axis, and rotate about the y-axis.

28. A juvenile product according to claim 26, wherein the launching surface is either a surface on the juvenile product or a support surface on which the juvenile product rests.
